(19) United States
(12) Patent Application Publication
(10) Pub. No.: US 2026/0168820 A1
(43) Pub. Date: Jun. 18, 2026

(54) DEVICE FOR DETECTING RELATIVE POSITION WITH CIRCUIT BREAKER

(71) Applicant: FinX, Le Havre (FR)

(72) Inventors: Harold Guillemin, Seine-Port (FR); Vincent Randon, Etouy (FR); Isaline Six, Serres-Morlaas (FR)

(21) Appl. No.: 18/710,332

(22) PCT Filed: Nov. 15, 2022
(86) PCT No.: PCT/EP2022/082027

§ 371 Date: Mar. 6, 2026

(30) Foreign Application Priority Data
Nov. 15, 2021 (FR) FR2112073

(51) Int. Cl. G01D 5/14

(52) U.S. Cl. CPC G01D 5/145

(57) ABSTRACT

A device for detecting the relative position of a movable part relative to a stationary part includes magnetic means arranged to emit a magnetic field, a first member bearing at least one magnetic sensor, and a second member bearing at least some of the magnetic means. The first and second members are arranged to be rotated or translated relative to one another. The at least one magnetic sensor is arranged relative to the magnetic means so as to detect a predetermined magnetic flux. The magnetic means includes at least one magnetic emission means and a removable magnetic guide element arranged at an influencing distance from the at least one magnetic sensor and/or from the at least one magnetic emission means so as to interact with the magnetic flux therebetween.

### CROSS REFERENCE TO RELATED APPLICATIONS

This application is a national phase entry under 35 U.S.C. § 371 of International Patent Application PCT/EP2022/082027, filed Nov. 15, 2022, designating the United States of America and published as International Patent Publication WO 2023/084123 A1 on May 19, 2023, which claims the benefit under Article 8 of the Patent Cooperation Treaty to French Patent Application Serial No. FR2112073, filed Nov. 15, 2021.

### TECHNICAL FIELD

The present disclosure concerns a device for detecting the relative position of a movable part with respect to a stationary part, for example, during a rotational or translational movement.

The invention relates more particularly to a rotation detection device comprising a gripping member and control means so as to produce a control device for an ancillary system.

The detection device is intended, in particular, for control devices such as control boxes, emergency stop devices with integrated variable speed drives, gas control handles for land vehicles, in particular, two-wheelers, or watercraft, or in the aeronautical field.

### BACKGROUND

Measuring devices comprising a Hall effect sensor are known, the latter comprising the sensor and a permanent magnet moving in the vicinity of the sensor so as to vary the magnetic flux or field perceived by the sensor, the variation enabling the measurement to be performed.

In addition, some systems comprise a circuit-breaking element for shutting down the systems equipped with the measuring device or the control device itself equipped with the measuring device. This circuit-breaker element is a permanent magnet that, while the system is operating, is arranged on a circuit-breaker support. The systems therefore comprise an electronic circuit for the Hall effect sensor and another electronic circuit for the circuit breaker.

It is desirable to offer a simplified, less costly device, while still providing the functions of detecting the position of the movable part and stopping the system in an emergency.

### BRIEF SUMMARY

To this end, and according to a first aspect, the present disclosure proposes a device for detecting the relative position of a movable part with respect to a stationary part comprising:
magnetic means arranged to emit a magnetic field,
a first member bearing at least one magnetic sensor,
a second member bearing at least some of the magnetic means,
the first and second members being arranged to be rotated or translated relative to one another, and
the at least one magnetic sensor being arranged relative to the magnetic means so as to detect a predetermined magnetic flux,
wherein the magnetic means comprise at least one magnetic emission means and a removable magnetic guide element, the magnetic guide element being arranged at an influencing distance from the at least one magnetic sensor and/or from the at least one magnetic emission means so as to interact with the magnetic flux between the at least one magnetic emission means and the at least one magnetic sensor.

The device according to the present disclosure offers an arrangement comprising fewer parts, thereby reducing the cost of the device compared with devices of the prior art.

According to various embodiments, the first member can be either the stationary part or the movable part. Conversely, the second member can be either the movable part or the stationary part. According to one example of the relative position detection device, the first member is the stationary part and the second member is the movable part.

Preferably, the magnetic guide element is arranged on the first or second member, or is arranged on a part fixedly connected to the first or second member. The magnetic guide element can be placed anywhere, as long as it is within range of, or acts on, the magnetic field of the at least one magnetic transmitter.

In one embodiment, the magnetic guide element is arranged on a peripheral surface of the first or second member.

According to a particular embodiment, the magnetic guide element is arranged, during operation, between the at least one magnetic sensor and the at least one magnetic emission means.

For the purposes of the foregoing and for the remainder of the description, the term “influencing distance” refers to the distance chosen to modify the magnetic field lines and/or magnetic flux around or between the at least one magnetic emission means and/or magnetic sensor, depending on the characteristics of the torque selected from the magnetic means and from the at least one magnetic sensor. In normal operation, the detection device is arranged to detect or measure the displacement of the movable part relative to the stationary part with the magnetic guide element arranged on the device.

Preferably, the detection device further comprises an emergency support arranged to receive the magnetic guide element. In normal operation, the magnetic guide element is arranged on the emergency support. In the event of a stop, e.g., due to an emergency situation, the magnetic guide element is removed or detached from the emergency support.

During the manufacture of the detection device, the at least one magnetic sensor can be calibrated with and without the presence of the magnetic guide element, in order to obtain reference magnetic field values. Depending on the position of the movable part relative to the stationary part, magnetic field values are deduced between the distal ends of the movable part's movement and in both cases: with and without the presence of the magnetic guide element. During operation, the measured magnetic field value(s) are compared with the reference values.

In one embodiment, the magnetic guide element is held on the emergency support by magnetic attraction.

In one embodiment, the magnetic guide element is a permanent magnet or ferromagnetic element, or an electric coil. In the case of a ferromagnetic element, the magnetic guide element may comprise or be made of stainless steel, for example, 420 stainless steel, or 430 stainless steel.

According to alternative embodiments, the magnetic guide element can be combined or alternatively:
increase the magnetic field relative to the magnetic field value of the at least one magnetic emission means,
decrease the magnetic field relative to the magnetic field value of the at least one magnetic emission means,
emit a magnetic field that does not disturb the magnetic field of the at least one magnetic emission means, but that is perceived by the at least one magnetic sensor, and
redirect the magnetic field lines of the at least one magnetic emission means.

Preferably, the magnetic guide element can be of any shape, such as cylindrical or rectangular. According to one embodiment, it may be disc-shaped. In another embodiment, it may be ring-, half-ring-, or fork-shaped. In the latter case, the ring or half-ring or fork can be fitted onto a circumferential surface of the first or second member or a gripping member.

The magnetic means, preferably the at least one magnetic emission means, are spaced by an air-gap distance from the at least one magnetic sensor. The at least one magnetic sensor is configured to detect a variation in the magnetic flux density of the at least one non-contacting opposing magnetic emitting means and has an upper and a lower limit value of a detectable magnetic flux density. In another embodiment, the at least one magnetic sensor can come into contact with the at least one magnetic emission means.

Preferably, the at least one magnetic sensor comprises at least one Hall effect sensor.

In one embodiment, the at least one magnetic sensor comprises a first Hall effect sensor and a second magnetic sensor.

Preferably, the at least one magnetic emission means is at least one permanent magnet. In one variant, the at least one magnetic emission means comprises a magnet and a magnetic emission adjustment means. Preferably, the magnetic emission adjustment means can be a ferromagnetic body or a permanent adjustment magnet. In the case of a magnetic emission adjustment means corresponding to a permanent magnet, known as a permanent adjustment magnet, the latter has a lower magnetization than the magnetization generated by the at least one magnetic emission means. The magnetic emission adjustment means enables the magnetic flux emission of the at least one magnetic emission means to be set or adjusted.

In one embodiment, the at least one magnetic emission means comprises a permanent magnet, the magnetic emission adjustment means comprises a permanent adjustment magnet, and the magnetic guide element is a ferromagnetic part.

According to a first family of embodiments, the first and second members each have an axis of rotation and are arranged for rotational movement relative to one another. According to one embodiment, the first and second members each have an axis of rotation and are arranged to be rotated relative to one another.

Particularly in the case of the first family of embodiments, the magnetic guide element is arranged on a distal cross-section of the first or second member. In one embodiment, the magnetic guide element has a face that covers the cross-section and distal section.

Particularly in the case of the first family of embodiments, the device further comprises a gripping member mechanically connected to the movable part of the detection device, and the magnetic guide element is arranged on a distal cross-section of the gripping member. Preferably, the gripping member is fitted onto the movable part. Preferably, the at least one magnetic sensor and the magnetic means are arranged near or at the end of the movable part of the detection device.

In another embodiment, the magnetic guide element is arranged on a circumferential and proximal surface of the gripping member, with the proximal end opposite the distal end.

According to a second family of embodiments, the first or second member has a rectilinear longitudinal direction, and the first and second members are arranged to be translated relative to each other.

Preferably, the detection device also includes an element for stopping the rotational or translational movement between the movable part and the stationary part. For example, the stopping element is a protruding protuberance that cooperates with a finger or a concavity to stop the movable part relative to the stationary part. In this way, the user has a better feel for the end-of-travel position of the movable part, compared with a stopper that has no protuberance. However, this type of design can create movement of the at least one magnetic emission means unrelated to the movement of the movable part relative to the stationary part, and disrupt the measurement of the magnetic sensor. If a stopping element, in particular, a protuberance, is added, the calibration of the magnetic sensor involves moving the movable part relative to the stationary part as far as the stop element, with and without the presence of the magnetic guide element, so as to obtain reference magnetic field values related to the stopping element. In particular, this calibration step prevents confusion between a specific position of the movable part with respect to the stationary part, and a detachment or absence of the magnetic guide element.

Preferably, the detection device comprises control means arranged to convert measurement data from the at least one magnetic sensor into control data for controlling another system so as to produce a control device.

According to a second aspect, the present disclosure proposes a motorized vehicle equipped with a control device comprising a relative position detection device according to one of the preceding claims.

### BRIEF DESCRIPTION OF THE DRAWINGS

Other features and advantages of the present disclosure will emerge from the following detailed description of example embodiments the present disclosure with reference to the appended figures:

FIG. 1 shows a cross-sectional view of a control device comprising a device for detecting the relative position between a stationary part and a movable part according to one example embodiment; and

FIG. 2 shows a perspective view of the control device shown in the figure, the view being partially transparent.

For greater clarity, identical or similar elements of the various embodiments are denoted by identical reference signs in all of the figures.

### DETAILED DESCRIPTION

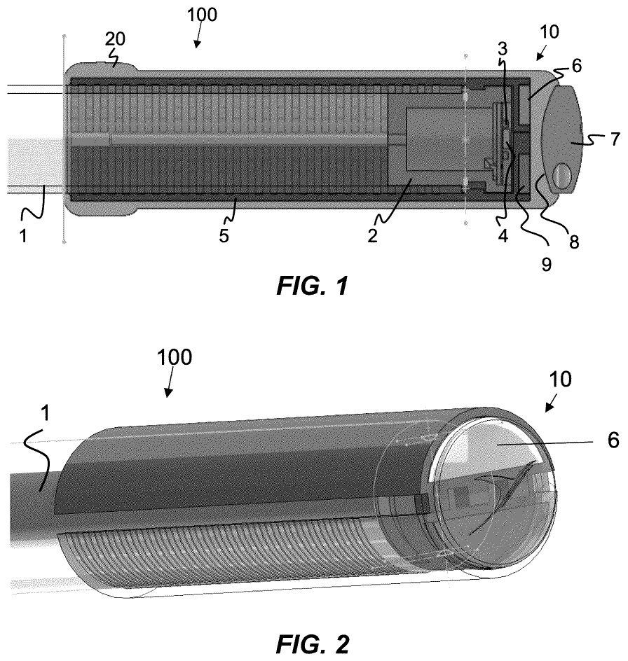

In relation to FIG. 1, a control device 100 comprising a position detection device 10 and a gripping member 20 is described. The gripping member comprises or is made of plastic. Preferably, the plastic used is polyurethane 75 ShoreA.

The position detection device is connected to a stationary part 1 shown cylindrically in FIG. 1. The detection device 10 comprises a sensor support 2 attached to an axial end of the stationary part 1.

Preferably, the detection device comprises an analog Hall effect sensor 3 and a magnetic angular sensor 4 arranged on a transverse face of the sensor support 2. In particular, the Hall effect sensor is designed to cooperate with a permanent magnet, the latter being arranged on the movable part of the device. The angle sensor is centered on the axis of rotation.

The position detection device comprises a movable part 5 surrounding the stationary part 1 and the sensor support 2. The movable part 5 is pivotably connected to the stationary part, in particular, to the circumferential surface of the sensor support. The device comprises magnetic means arranged to cooperate with the magnetic sensor, preferably the Hall effect sensor. During operation, the position of the movable part is measured by the variation in the magnetic field detected by the sensor.

The magnetic means comprise at least one magnetic field emission means arranged on a transverse face of the movable part 5. Once the movable part has been assembled on the stationary part, the at least one emission means is located at a distance enabling the magnetic flux generated by the emission means to be perceived by the sensor. Preferably, the magnetic emission means is a permanent magnet 6. With reference to FIG. 2, the permanent magnet 6 is shaped like a half-disc. In other embodiments not shown, the permanent magnet 6 can have any shape, for example, a rectangular shape.

Optionally shown in FIG. 1, the at least one magnetic emission means further comprises a magnetic emission adjustment means 9. The magnetic emission adjustment means 9 enables the magnetic field of the magnetic emission means, in particular, the permanent magnet 6, to be slightly reoriented to increase accuracy. In various embodiments, the adjustment means 9 can be a ferromagnetic plate or a second permanent magnet.

The magnetic means also comprise a removable magnetic guide element 7. The magnetic guide element is arranged at an influencing distance from the Hall effect sensor and the permanent magnet so as to interact with the magnetic flux between them. With reference to FIG. 1, the magnetic guide element 7 is arranged on the distal transverse face 8 of the gripping member 20. The distal transverse face 8 presents or makes an emergency support to receive the magnetic guide element 7. The permanent magnet 6 is separated from the magnetic guide element 7 by a transverse wall of the gripping member 20. The transverse wall is an emergency support for receiving the magnetic guide element 7. The magnetic guide element 7 is held in position by the effect of the magnetic field. In an emergency, this magnetic guide element 7 can be removed from the device. The Hall effect sensor detects an abnormal or unanticipated variation during calibration, enabling a circuit breaker to be triggered.

In operation, data is retrieved from the analog Hall effect sensor 3, which returns values between 0 and 1024 as a function of the magnetic field around it. The values are predetermined by the presence of the magnetic guide element 7, which is attracted by the magnetic field. Preferably, the magnetic guide element 7 is formed of 430 stainless steel.

Data from the magnetic angle sensor can be used to determine the position of a movable part, such as a handle. The sensor returns values from 0 to 1024 to cover an angle of 180°, preferably to cover a range of angle values from 0 to 135°.

These values can be used to control another system: for a 0° movement, the system is switched off, and for a 135° movement, the system runs at full speed. Between the two, the variation of the controlled parameter follows a linear law.

The invention is described in the foregoing by way of example. It is understood that a person skilled in the art is able to produce different variant embodiments of the present disclosure without departing from the scope of the invention as defined by the claims.

1. A detection device for detecting the relative position of a movable part with respect to a stationary part, comprising:
magnetic means configured to emit a magnetic field;
a first member bearing at least one magnetic sensor; and
a second member bearing at least some of the magnetic means, the first and second members being arranged to be rotated or translated relative to one another, the at least one magnetic sensor being arranged relative to the magnetic means so as to detect a predetermined magnetic flux;
wherein the magnetic means comprises at least one magnetic emission means and a removable magnetic guide element, and the magnetic guide element is arranged at an influencing distance from the at least one magnetic sensor and/or from the at least one magnetic emission means so as to interact with the magnetic flux between the at least one magnetic emission means and the at least one magnetic sensor.

2. The detection device of claim 1, wherein the removable magnetic guide element is arranged on the first member or the second member, or is arranged on a part fixedly connected to the first member or the second member.

3. The detection device of claim 1, wherein the at least one magnetic sensor comprises at least one Hall effect sensor.

4. The detection device of claim 1, wherein the at least one magnetic sensor comprises a first Hall effect sensor and a second magnetic sensor.

5. The detection device of claim 1, wherein the at least one magnetic emission means comprises at least one permanent magnet.

6. The detection device of claim 1, wherein the at least one magnetic emission means comprises a magnet and a magnetic emission adjustment means.

7. The detection device of claim 1, wherein the magnetic guide element is a permanent magnet or a ferromagnetic element or an electric coil.

8. The detection device of claim 1, further comprising an element configured to stop rotational or translational movement between the movable part and the stationary part.

9. The detection device of claim 1, wherein the first member and the second member are arranged to be rotated relative to one another about an axis of rotation.

10. The detection device of claim 9, wherein the magnetic guide element is arranged on a surface of the first member or the second member, the surface oriented transverse to the axis of rotation.

11. The detection device of claim 8, further comprising a gripping member mechanically connected to the movable part of the detection device, and wherein the surface on which the magnetic guide element is arranged is a surface of the gripping member.

12. A motorized vehicle with a control device comprising a detection device according to claim 1.

13. A detection device for detecting a relative position of a movable part with respect to a stationary part, the detection device comprising:
a magnetic element emitting a magnetic field;
a first member bearing at least one magnetic sensor; and
a second member bearing at least a portion of the magnetic element, the first member and the second member located and configured to be rotated or translated relative to one another, the at least one magnetic sensor located relative to the magnetic element and configured so as to detect a predetermined magnetic flux;
wherein the magnetic element includes at least one magnetic emission element and a removable magnetic guide element, and the magnetic guide element is arranged at an influencing distance from the at least one magnetic sensor and/or from the at least one magnetic emission element so as to interact with magnetic flux between the at least one magnetic emission element and the at least one magnetic sensor.

14. The detection device of claim 13, wherein the removable magnetic guide element is arranged on the first member or the second member, or is arranged on a part fixedly connected to the first member or the second member.

15. The detection device of claim 13, wherein the at least one magnetic sensor comprises at least one Hall effect sensor.

16. The detection device of claim 13, wherein the at least one magnetic sensor comprises a first Hall effect sensor and a second magnetic sensor.

17. The detection device of claim 13, wherein the at least one magnetic emission element comprises at least one permanent magnet.

18. The detection device of claim 13, wherein the at least one magnetic emission element comprises a magnet and a magnetic emission adjustment device.

19. The detection device of claim 13, wherein the magnetic guide element is a permanent magnet or a ferromagnetic element or an electric coil.

20. A motorized vehicle with a control device comprising a detection device according to claim 13.
